(19) United States
(12) Patent Application Publication
(10) Pub. No.: US 2018/0225398 A1
(43) Pub. Date: Aug. 9, 2018

(54) PROGRAM, METHOD, AND INFORMATION PROCESSING APPARATUS FOR CALCULATING HEAT DENSITY

(71) Applicant: FUJITSU LIMITED, Kawasaki-shi (JP)

(72) Inventor: Akira Sakai, Kawasaki (JP)

(73) Assignee: FUJITSU LIMITED, Kawasaki-shi (JP)

(21) Appl. No.: 15/886,910

(22) Filed: Feb. 2, 2018

(30) Foreign Application Priority Data
Feb. 8, 2017 (JP) 2017-021260

(51) Int. Cl. G06F 17/50; G01N 25/20; G01K 7/00

(52) U.S. Cl. CPC G06F 17/5009; G01K 17/00; G01K 7/00; G01N 25/20

(57) ABSTRACT

A method for calculating heat density including: executing first simulation of calculating a temperature of each of temperature cells of temperature plane associated one-to-one with each of heat generation cells of heat generation plane with a heat density of heat generation cell set at a first heat density, and storing first temperature information; executing a second simulation of calculating a temperature of the temperature plane when the heat density is set to a second heat density obtained by adding a fixed value to each first heat density and storing second temperature information; calculating a change coefficient indicating a change amount of the temperature with respect to a change amount of the heat density for each of the heat generation cells; determining a heat density of each heat generation cells based on the change coefficients so that the temperature of each of temperature cells reaches a desired target temperature.

### CROSS-REFERENCE TO RELATED APPLICATION

This application is based upon and claims the benefit of priority of the prior Japanese Patent Application No. 2017-21260, filed on Feb. 8, 2017, the entire contents of which are incorporated herein by reference.

### FIELD

The embodiments discussed herein are related to a computer program, a method, and an information processing apparatus for calculating heat density.

### BACKGROUND

Various methods have been developed for calculating the heat density of a heat source, such as a heat generation member, and the temperature of a member heated by the heat source, for example, estimating a temperature distribution when a metal member is induction-heated, by executing thermofluid analytical simulation (see, for example, Japanese Laid-open Patent Publication No. 2013-050805).

However, the known heat-density calculation methods can increase the number of times to execute the simulation with increases in the number of heat generating elements, the number of positions of the heat generating elements, the amount of heat generated from the heat generating elements, or other parameters. For example, in the case where a flat heat generation plane is divided into a plurality of heat generation cells, and the heat density of each of the plurality of heat generation cells at which the temperature of a temperature plane heated by the heat generation plane reaches a desired temperature is to be calculated, the accuracy of simulation increases as the number of heat generation cells that divide the heat generation plane is increased. Meanwhile, the number of times to execute the simulation increases as the number of heat generation cells that divide the heat generation plane increases, so that the cost of the heat density calculating process, such as simulation time, can increase.

### SUMMARY

According to an aspect of the invention, a method for calculating heat density including: executing first simulation of calculating a temperature of each of temperature cells of temperature plane associated one-to-one with each of heat generation cells of heat generation plane with a heat density of heat generation cell set at a first heat density, and storing first temperature information; executing a second simulation of calculating a temperature of the temperature plane when the heat density is set to a second heat density obtained by adding a fixed value to each first heat density and storing second temperature information; calculating a change coefficient indicating a change amount of the temperature with respect to a change amount of the heat density for each of the heat generation cells; determining a heat density of each heat generation cells based on the change coefficients so that the temperature of each of temperature cells reaches a desired target temperature.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a flowchart illustrating the process of a relating heat density calculation method according to an embodiment;

FIG. 1B is a diagram for illustrating the process of S901;

FIG. 1C is a first diagram for illustrating the process of S902;

FIG. 1D is a second diagram for illustrating the process of S902;

FIG. 1E is a third diagram for illustrating the process of S902;

FIG. 1F is a fourth diagram for illustrating the process of S902;

FIG. 2A is a circuit block diagram of an information processing apparatus according to an embodiment;

FIG. 2B is a functional block diagram of a processing unit illustrated in FIG. 2A;

FIG. 3 is a flowchart for a simulation-model generation process performed by the information processing apparatus illustrated in FIG. 2A;

FIG. 4A is a diagram for illustrating the process of S101;

FIG. 4B is a diagram for illustrating the process of S102;

FIG. 4C is a diagram for illustrating the process of S103;

FIG. 4D is a diagram for illustrating the process of S104;

FIG. 4E is a diagram for illustrating the process of S105;

FIG. 4F is a diagram for illustrating the process of S106;

FIG. 5 is a flowchart for a heat-density calculation process performed by the information processing apparatus illustrated in FIG. 2A;

FIG. 6 is a diagram for illustrating a thermofluid analytical simulation;

FIG. 7A is a diagram illustrating the heat density calculation method according to the present embodiment;

FIG. 7B is a diagram illustrating the difference between the heat density calculation method according to the embodiment and a heat density calculation method based on a thermogenic response matrix methodology;

FIG. 8A is a graph illustrating an example of the calculation results of heat density by the heat density calculation method according to the present embodiment;

FIG. 8B is a graph illustrating an example of the calculation results of heat density by the heat density calculation method according to the present embodiment when the number of heat generation cells is changed; and

FIG. 8C is a graph illustrating the comparison result of the number of executions of thermofluid analytical simulation by the heat density calculation method according to the present embodiment and the heat density calculation method based on the thermogenic response matrix methodology.

### DESCRIPTION OF EMBODIMENTS

A computer program, a method, and an information processing apparatus for calculating heat density will be described hereinbelow with reference to the drawings. It is to be understood that the technical scope of the present disclosure is not limited to the following embodiments.

Method for Calculating Heat Density Relating to Method for Calculating Heat Density According to Embodiment

A method for calculating heat density relating to a method for calculating heat density according to an embodiment will be described before a computer program, a method, and an information processing apparatus for calculating heat density according to an embodiment are described.

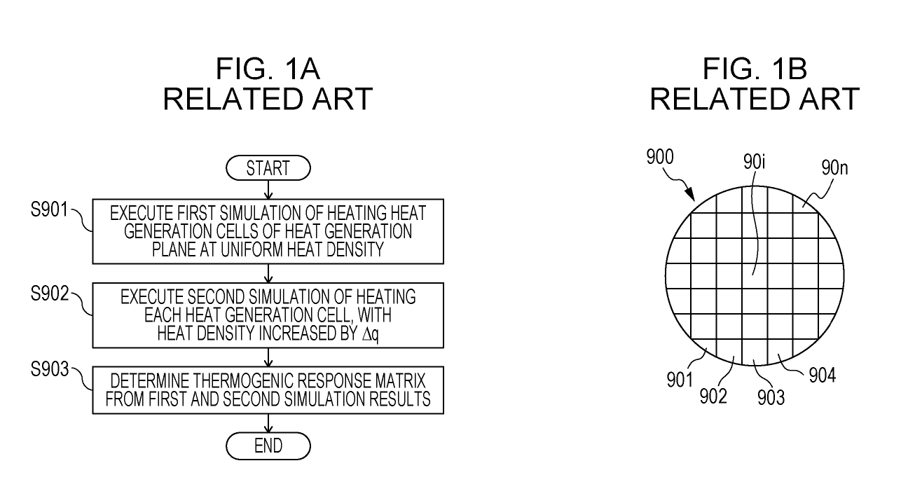

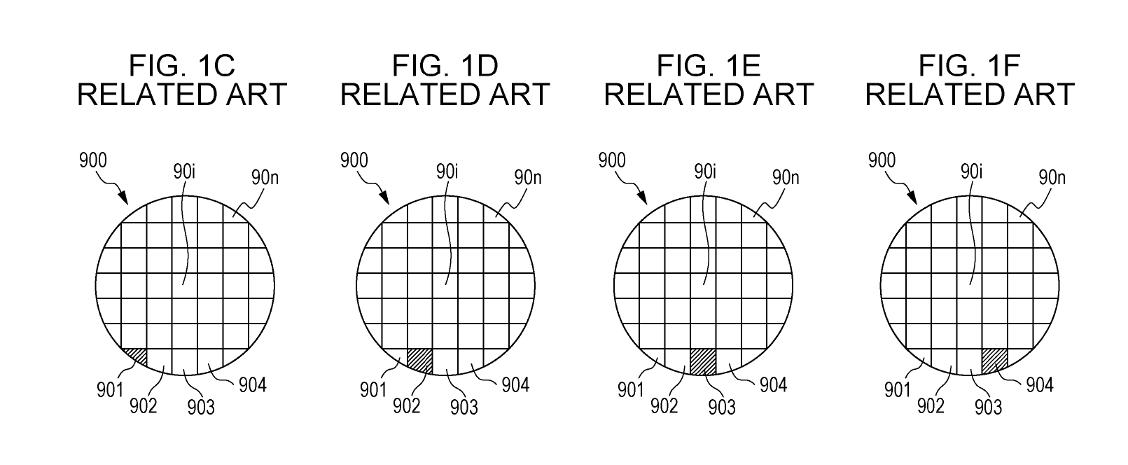

FIGS. 1A to 1F are diagrams illustrating the method for calculating heat density relating to the method for calculating heat density according to the embodiment. FIG. 1A is a flowchart illustrating the process of the relating heat density calculation method. FIG. 1B is a diagram for illustrating the process of S901. FIG. 1C is a first diagram for illustrating the process of S902. FIG. 1D is a second diagram for illustrating the process of S902. FIG. 1E is a third diagram for illustrating the process of S902. FIG. 1F is a fourth diagram for illustrating the process of S902.

The heat density calculation method relating to the method for calculating heat density according to the embodiment is a modification of a thermogenic response surface methodology and is also referred to as a thermogenic response matrix methodology. The thermogenic response surface methodology is a method for calculating the physical quantity of an input by approximating heat density, which is the physical quantity of the input, using an expression representing a surface temperature response surface, which is the physical quantity of an output relative to the input, and solving the expression. An example of the surface temperature response surface in the thermogenic response surface methodology is expressed as Exp. (1).

$$( \begin{matrix}Δ {T}_{1} \\ ⋮ \\ Δ {T}_{i} \\ ⋮ \\ Δ {T}_{n}\end{matrix} ) = ( {A}_{ij} ) ( \begin{matrix}Δ {Q}_{1} \\ ⋮ \\ Δ {Q}_{i} \\ ⋮ \\ Δ {Q}_{n}\end{matrix} ) + ( {A}_{ij} ) {( \begin{matrix}Δ {Q}_{1} \\ ⋮ \\ Δ {Q}_{i} \\ ⋮ \\ Δ {Q}_{n}\end{matrix} )}^{2} … \qquad ( 1 )$$

In the thermogenic response matrix methodology, the physical quantity of an input is calculated on the assumption that the physical quantity of an output is linear with respect to the physical quantity of the input while ignoring the second and subsequent terms in the expression representing the response surface. An example of the surface temperature response surface in the thermogenic response matrix methodology is expressed as Exp. (2).

$$( \begin{matrix}Δ {T}_{1} \\ ⋮ \\ Δ {T}_{i} \\ ⋮ \\ Δ {T}_{n}\end{matrix} ) = ( {A}_{ij} ) ( \begin{matrix}Δ {Q}_{1} \\ ⋮ \\ Δ {Q}_{i} \\ ⋮ \\ Δ {Q}_{n}\end{matrix} ) \qquad ( 2 )$$

In the thermogenic response matrix methodology, a thermogenic response matrix Aᵢⱼ is calculated by an information processing apparatus (not illustrated) executing the processes from S901 to S903 illustrated in FIG. 1A. First, the information processing apparatus executes a first simulation in a state in which the heat densities of all of a plurality of heat generation cells 901 to 90n of a heat generation plane 900 are set to heat density Q0 (S901). The first simulation is a thermofluid analytical simulation which is also referred to as computational fluid dynamics (CFD).

At S901, the respective heat densities q1 to qn of the plurality of heat generation cells 901 to 90n are Q0. In the first simulation, the information processing apparatus acquires the temperatures T01 to T0n of temperature cells (not illustrated) associated one-to-one with the plurality of heat generation cells 901 to 90n. The plurality of temperature cells are formed by dividing a target temperature plane (not illustrated).

Next, the information processing apparatus executes a second simulation in a state in which the heat density of a single heat generation cell is increased by Δq (S902). The second simulation is a thermofluid analytical simulation like the first simulation. First, as illustrated in FIG. 1C, the information processing apparatus executes the first second simulation, with the heat density of the heat generation cell 901 increased by Δq into (Q0+Δq), and the heat densities of the heat generation cells 902 to 90n set at Q0. In the first simulation, the information processing apparatus acquires the temperatures T11 to T1n of the temperature cells.

Next, as illustrated in FIG. 1D, the information processing apparatus executes the second simulation, with the heat density of the heat generation cell 902 increased by Δq into (Q0+Δq), and the heat densities of the heat generation cells 901 and 903 to 90n set at Q0. In the second simulation, the information processing apparatus acquires the temperatures T21 to T2n of the temperature cells.

Similarly, as illustrated in FIGS. 1E and 1F, the information processing apparatus executes the third and fourth second simulations, with the heat densities of the heat generation cells 903 and 904 increased by Δq in sequence. In the third and fourth second simulations, the information processing apparatus respectively acquires the temperatures T31 to T3n and T41 to T4n of the temperature cells. The information processing apparatus executes the i-th second simulation, with the heat density of a heat generation cell 90i increased by Δq into (Q0+Δq), and the heat densities of the heat generation cells 901 to 90(i−1) and 90(i+1) to 90n set at Q0. In the i-th second simulation, the information processing apparatus acquires the temperatures Ti1 to Tin of the temperature cells.

The information processing apparatus executes the n-th second simulation, with the heat density of the heat generation cell 90n increased by Δq into (Q0+Δq), and the heat densities of the heat generation cells 901 to 90(n−1) set at Q0. In the n-th second simulation, the information processing apparatus acquires the temperatures Tn1 to Tnn of the temperature cells.

Next, the information processing apparatus determines the thermogenic response matrix Aᵢⱼ from the results of the first simulation and the second simulation (S903). The information processing apparatus determines an element aᵢⱼ of the thermogenic response matrix Aᵢⱼ in sequence. The element aᵢⱼ is given by

aᵢⱼ=(Tᵢⱼ−Tₒᵢ)/AΔq

because Tᵢⱼ=a_{ij*Δq}

where Tᵢⱼ is the temperature of a temperature cell corresponding to the heat generation cell 90j when the amount of heat generated in the heat generation cell 90i is increased by Δq, and Tₒᵢ, is the temperature of a temperature cell corresponding to the heat generation cell 90i in the first simulation.

The information processing apparatus calculates temperature change amounts ΔTᵢ to ΔTₙ from

ΔTᵢ=Tᵢⱼ−Tₒⱼ.

The information processing apparatus calculates the change amount ΔQᵢ(=Qᵢ−Q0) of heat density by solving Exp. (2) for thermogenic response for temperature change amount ΔTᵢ.

In the thermogenic response matrix methodology, the first simulation of heating the heat generation plane 900 at the uniform heat density Q0 is executed, and thereafter, n times of second simulation of heating the heat generation cells 901 to 90n, with the heat density increased by Δq, are executed. The number of executions of thermofluid analytical simulation in the thermogenic response matrix methodology is (n+1) as the sum of one time of the first simulation and n times of the second simulation. In the thermogenic response matrix methodology, the number of executions of the thermofluid analytical simulation increases as the number n of the heat generation cells that divide the heat generation plane increases. Consequently, the cost of heat density calculation process increases as the number n of the heat generation cells increases.

Outline of Information Processing Apparatus According to Embodiment

The information processing apparatus according to the embodiment executes the first simulation, with the heat density of the heat generation plane set at a first heat density, and then executes the second simulation, with the heat density of the heat generation plane set to a second heat density obtained by adding a fixed value to the first heat density. The information processing apparatus according to the embodiment calculates a change coefficient indicating the change amount of the temperature with respect to the change amount of the heat density for each of a plurality of heat generation cells from the difference in temperature of a plurality of temperature cells between the temperature corresponding to first temperature information and the temperature corresponding to the second temperature information. The information processing apparatus according to the embodiment determines the heat density of each of the plurality of heat generation cells so that the temperature of each of the plurality of temperature cells reaches a desired target temperature based on the change coefficient. The information processing apparatus according to the embodiment can calculate the heat density accurately with fewer execution times of simulation by determining the heat density of each of the plurality of heat generation cells based on the change coefficient indicating the change amount of the temperature with respect to the change amount of the heat density.

Configuration and Function of Information Processing Apparatus According to Embodiment

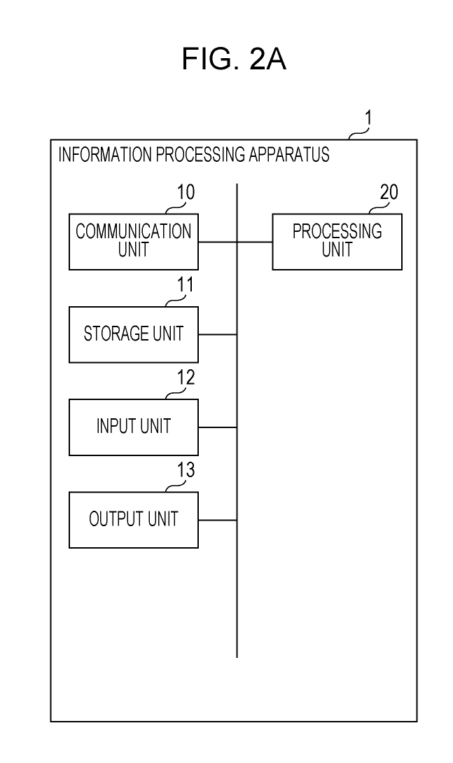

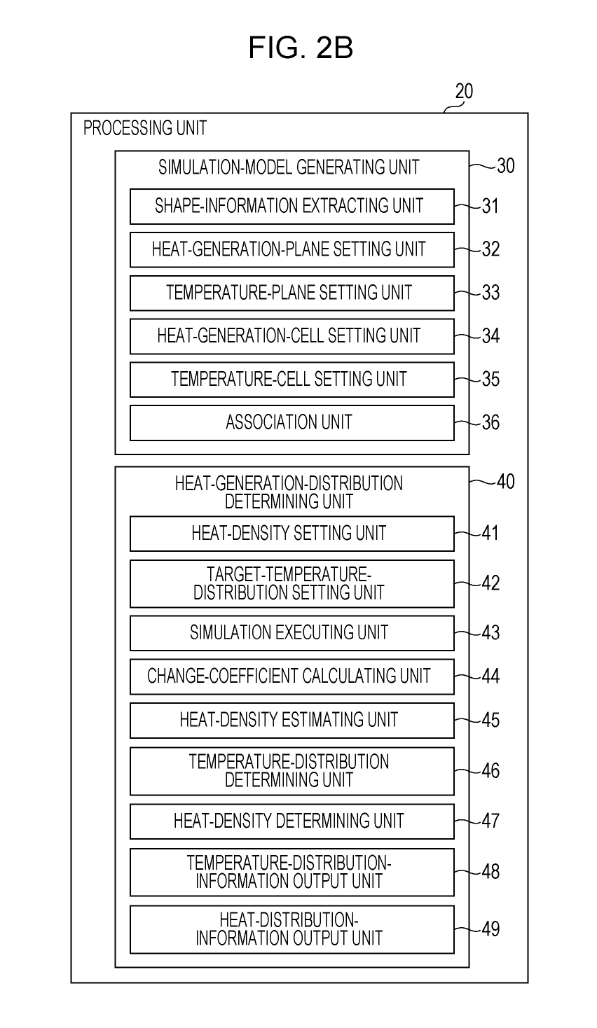

FIG. 2A is a circuit block diagram of an information processing apparatus 1 according to an embodiment. FIG. 2B is a functional block diagram of a processing unit 20 illustrated in FIG. 2A.

The information processing apparatus 1 includes a communication unit 10, a storage unit 11, an input unit 12, an output unit 13, and the processing unit 20.

The communication unit 10 communicates with a server or the like (not illustrated) via the Internet according to Hypertext Transfer Protocol (HTTP). The communication unit 10 provides data received from the server or the like to the processing unit 20. The communication unit 10 transmits the data provided from the processing unit 20 to the server or the like.

The storage unit 11 includes at least one of a semiconductor device, a magnetic tape device, a magnetic disk device, and an optical disk device. The storage unit 11 stores an operating system program, a driver program, an application program, data, and so on. For example, the storage unit 11 stores, as an example of the application program, a simulation-model generation program for causing the processing unit 20 to execute a simulation-model generation process for generating a simulation model of the thermofluid analytical simulation. The storage unit 11 also stores, as an example of the application program, a heat-density calculation program for causing the processing unit 20 to execute a heat-density calculation process for calculating heat density at which the temperature of the temperature plane reaches a desired target temperature. The heat-density calculation program may be installed in the storage unit 11 from a computer-readable portable storage medium, such as a compact disc read-only memory (CD-ROM), a digital versatile disc read-only memory (DVD-ROM), using a known setup program or the like.

The storage unit 11 also stores, as the data, data for use in an input process. The storage unit 11 may also temporarily store data for temporary use in an input process or the like.

The input unit 12 may be any device that can input data, for example, a touch panel or key buttons. The operator can enter letters, numbers, symbols, and so on using the input unit 12. When operated by the operator, the input unit 12 generates a signal corresponding to the operation. The generated signal is provided to the processing unit 20 as an instruction of the operator.

The output unit 13 may be any device that can display images or frames, for example, a liquid crystal display or an organic electro-luminescence (EL) display. The output unit 13 displays an image corresponding to image data or a frame corresponding to video data provided from the processing unit 20. The output unit 13 may be an output unit that prints images, frames, letters, or the like on a display medium, such as paper.

The processing unit 20 includes one or a plurality of processors and a peripheral circuit thereof. The processing unit 20 controls the overall operation of the information processing apparatus 1, an example of which is a CPU. The processing unit 20 executes processing based on programs (the driver program, the operating system program, the application program, and so on) stored in the storage unit 11. The processing unit 20 can execute a plurality of programs (the application program and so on) in parallel.

The processing unit 20 includes a simulation-model generating unit 30 and a heat-generation-distribution determining unit 40. The simulation-model generating unit 30 includes a shape-information extracting unit 31, a heat-generation-plane setting unit 32, a temperature-plane setting unit 33, a heat-generation-cell setting unit 34, a temperature-cell setting unit 35, and an association unit 36. The heat-generation-distribution determining unit 40 includes a heat-density setting unit 41, a target-temperature-distribution setting unit 42, a simulation executing unit 43, a change-coefficient calculating unit 44, a heat-density estimating unit 45, a temperature-distribution determining unit 46, and a heat-density determining unit 47. The heat-generation-distribution determining unit 40 further includes a temperature-distribution-information output unit 48 and a heat-distribution-information output unit 49. The above units are functional modules that are implemented according to programs executed by the one or the plurality of processors of the processing unit 20. Alternatively, the above units may be installed as firmware in the information processing apparatus 1.

Simulation-Model Generation Process by Information Processing Apparatus According to Embodiment

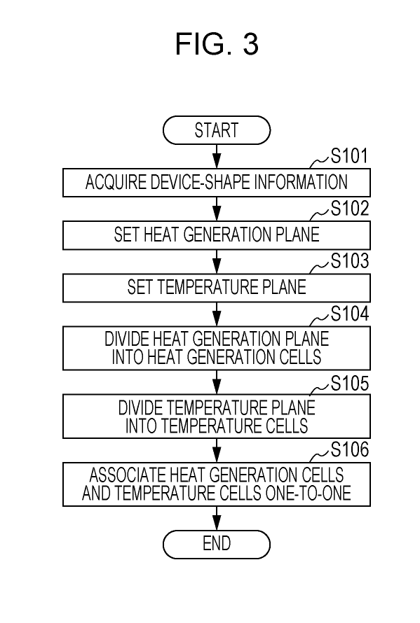

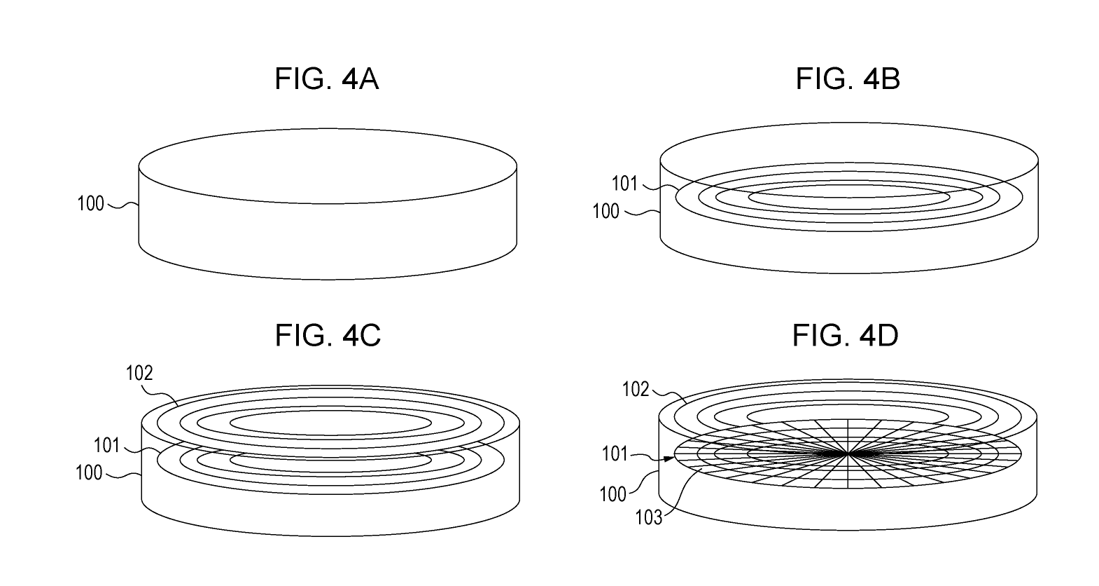

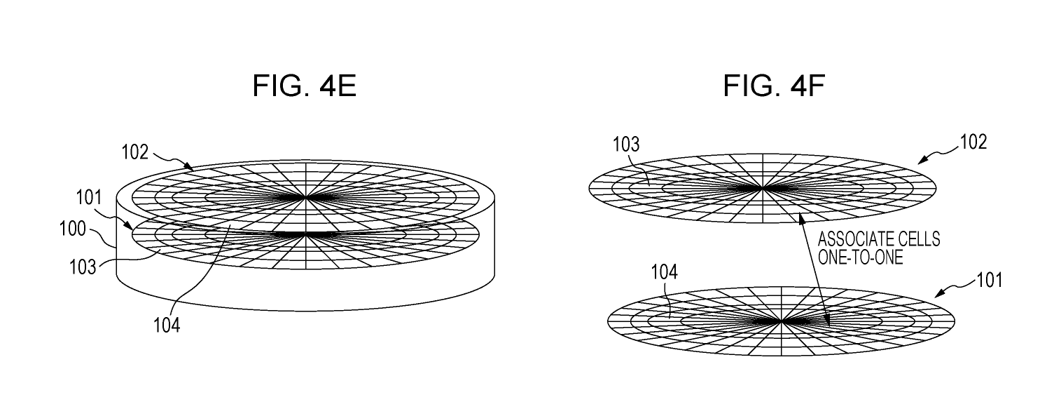

FIG. 3 is a flowchart for a simulation-model generation process performed by the information processing apparatus 1. FIGS. 4A to 4F are diagrams for illustrating the simulation-model generation process. FIG. 4A is a diagram for illustrating the process of S101. FIG. 4B is a diagram for illustrating the process of S102. FIG. 4C is a diagram for illustrating the process of S103. FIG. 4D is a diagram for illustrating the process of S104. FIG. 4E is a diagram for illustrating the process of S105. The simulation-model generation process illustrated in FIG. 3 is executed by the processing unit 20 based on a program stored in the storage unit 11 in cooperation with the components of the information processing apparatus 1.

First, the shape-information extracting unit 31 extracts shape information indicating the shape of a target device to be subjected to calculation of heat density from a computer-aided design (CAD) model of the target device (S101). In the example illustrated in FIG. 4A, the shape of a target device 100 corresponding to the shape information is cylindrical. The target device 100 to be subjected to the heat-density calculation process is a heating device, such as an electric stove.

Next, the heat-generation-plane setting unit 32 sets a heat generation plane 101 in the shape of the target device 100 extracted in the process of S101 (S102). In the example illustrated in FIG. 4B, the heat generation plane 101 is set as a circular plane in the device 100. The heat generation plane 101 is set according to an operation by the operator on the input unit 12 (not illustrated).

Next, the temperature-plane setting unit 33 sets a temperature plane 102 in the shape of the target device 100 extracted in the process of S101 (S103). In the example illustrated FIG. 4C, the temperature plane 102 is set as a circular plane on the upper surface of the device 100. The shape of the temperature plane 102 is the same as the shape of the heat generation plane 101, and the area of the temperature plane 102 is the same as the area of the heat generation plane 101. The temperature plane 102 is set according to an operation by the operator on the input unit 12 (not illustrated).

Next, the heat-generation-cell setting unit 34 divides the heat generation plane 101 set in the process of S102 to set a plurality of heat generation cells 103 (S104). In the example illustrated in FIG. 4D, the heat generation cells 103 are formed by dividing the circular heat generation plane 101 by concentric circles with different diameters and further dividing the divided concentric circles by a plurality of straight lines passing through the center of the heat generation plane 101 into sectors. The heat generation cells 103 are set according to an operation by the operator on the input unit 12 (not illustrated).

Next, the temperature-cell setting unit 35 divides the temperature plane 102 set in the process of S103 to set a plurality of temperature cells 104 (S105). In the example illustrated in FIG. 4E, the temperature cells 104 are formed by dividing the circular temperature plane 102 by concentric circles with different diameters and further dividing the divided concentric circles by a plurality of straight lines passing through the center of the temperature plane 102 into sectors. The number of the temperature cells 104 is the same as the number of the heat generation cells 103, and each of the plurality of temperature cells 104 formed in the heat generation plane 101 has the same shape as the shape of each heat generation cell 103 formed at a corresponding position of the heat generation plane 101. The temperature cells 104 are set according to an operation by the operator on the input unit 12 (not illustrated).

The association unit 36 associates the plurality of heat generation cells 103 set in the process of S104 and the plurality of temperature cells 104 set in the process of S105 on a one-to-one basis (S106). In the example illustrated in FIG. 4F, the plurality of temperature cells 104 formed in the heat generation plane 101 are associated with the heat generation cells 103 formed at corresponding positions of the heat generation plane 101. The association unit 36 stores a correspondence table in which the temperature cells 104 and the temperature cells 104 are associated one-to-one in the storage unit 11.

Table 1 is an example of the correspondence table stored in the storage unit 11.

TABLE 1

| Cell Number | 1 | 2 | 3 | . . . | n |
|---|---|---|---|---|---|
| Temperature (° C.) | 50 | 65 | 76 | . . . | 63 |
| Heat Density (W/cm²) | 1.2 | 2.3 | 3.2 | . . . | 7.5 |

Heat-Density Calculation Process by Information Processing Apparatus According to Embodiment

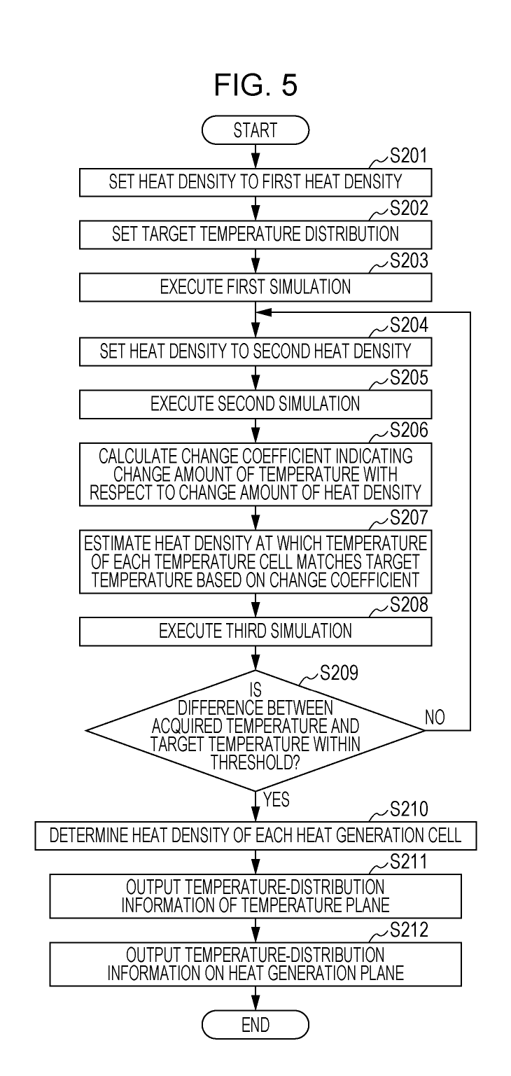

FIG. 5 is a flowchart for a heat-density calculation process performed by the information processing apparatus 1. The heat-density calculation process illustrated in FIG. 5 is executed mainly by the processing unit 20 in cooperation with the components of the information processing apparatus 1 based on a program stored in the storage unit 11.

First, the heat-density setting unit 41 sets the heat density q⁰(i) of all of a plurality of heat generation cells to a first heat density q⁰ so that the heat density of a heat generation plane in a simulation model generated by the simulation-model generating unit 30 becomes uniform (S201). Next, the target-temperature-distribution setting unit 42 sets a target temperature distribution of a temperature plane in the simulation model generated by the simulation-model generating unit 30 (S202). The target-temperature-distribution setting unit 42 sets the target temperature distribution of the temperature plane by setting a target temperature T_{target}(i) for each of temperature cells that divide the temperature plane. In one example, the target temperature T_{target}(i) of each temperature cells is T_{target}, so that the target temperature distribution of the temperature plane is uniform at the target temperature T_{target} over the entire temperature plane.

Next, the simulation executing unit 43 executes the first simulation, which is a thermofluid analytical simulation, in a state in which the heat densities q⁰(i) of all of the plurality of heat generation cells are set at the first heat density q⁰ (S203). The simulation executing unit 43 stores first temperature information indicating the respective temperatures T⁰(i) of the plurality of temperature cells calculated by executing the first simulation in the storage unit 11. The temperature of the first temperature cell is represented by T⁰(1), the temperature of the second temperature cell is represented by T⁰(2), and the temperature of the n-th temperature cell is represented by T⁰(n).

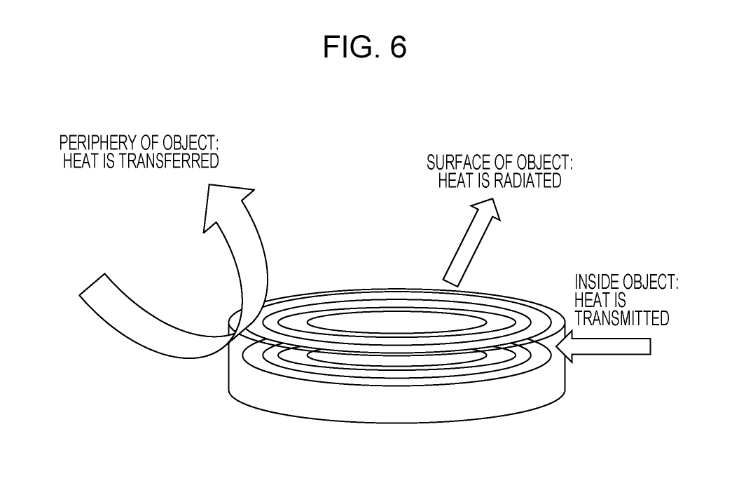

FIG. 6 is a diagram for illustrating the thermofluid analytical simulation.

The thermofluid analytical simulation is a simulation of calculating the temperatures of a plurality of temperature cells in a temperature plane from the respective heat densities of a plurality of heat generation cells in a heat generation plane according to a finite difference method, a finite volume method, a finite element method, or the like. In the thermofluid simulation, the temperatures of the plurality of temperature cells are calculated based on the influence of the respective heat densities of the plurality of heat generation cells, heat conduction inside the object, heat transfer due to convection of air around the object, and heat radiation from the surface of the object.

Next, the heat-density setting unit 41 sets the heat densities of all of the plurality of heat generation cells to a second heat density q¹_{search}(i) (=q⁰(i)+Δq) obtained by adding a fixed value Δq to each first heat density q⁰(i) (S204). Namely, different from the conventional method as explained by referencing FIG. 1A-1F, the heat density q¹_{search}(1) to q¹_{search}(n) of the first heat generation cell to the n-th heat generation cell are all set to (=q⁰+Δq). Next, the simulation executing unit 43 executes the second simulation, which is a thermofluid analytical simulation, in a state in which the heat densities of the plurality of heat generation cells are set at the second heat density q¹_{search}(1) to q¹_{search}(n) (S205). The simulation executing unit 43 stores second temperature information indicating the respective temperature T¹_{search}(i) of the plurality of temperature cells calculated by executing the second simulation in the storage unit 11. The temperature of the first temperature cell is represented by T¹_{search}(1), the temperature of the second temperature cell is represented by T¹_{search}(2), and the temperature of the n-th temperature cell is represented by T¹_{search}(n).

Next, the change-coefficient calculating unit 44 calculates a change coefficient indicating the change amount of the temperature with respect to the change amount of the heat density for each of the plurality of heat generation cells from the difference in the temperature of the plurality of temperature cells between the temperature corresponding to the first temperature information and the temperature corresponding to the second temperature information stored in the storage unit 11 (S206). The change-coefficient calculating unit 44 calculates a change coefficient a¹(i) using Exp. (3).

aⁿ(i)=(T_{search}ⁿ(i)−Tⁿ⁻¹(i)) [symbol] q (3)

In Exp. (3), n is 1, and i is a cell number assigned to each of the plurality of temperature cells. Here, “n” means an iteration number of the loop S204-S209 in FIG. 5.

Next, the heat-density estimating unit 45 estimates a third heat density q¹(i) at which the temperature of a corresponding temperature cell matches a target temperature for each of the plurality of heat generation cells based on the change coefficient aⁿ(i) (S207). The heat-density estimating unit 45 estimates the third heat density q¹(i) at which the temperature of the corresponding temperature cell matches the target temperature using Exp. (4).

$${q}^{n + 1} ( i ) = \frac{{T}_{target} ( i ) - {T}^{n - 1} ( i )}{{a}^{n} ( i )} + {q}^{n} ( i ) \qquad ( 4 )$$

In Exp. (4), n is 0, and i is a cell number assigned to each of the plurality of temperature cells. T⁰(i) represents a temperature corresponding to the first temperature information stored in the storage unit 11, and q⁰(i) is the heat density q⁰ of each of the plurality of heat generation cells.

Next, the simulation executing unit 43 executes a third simulation, which is a thermofluid analytical simulation, in a state in which the heat densities of all of the plurality of heat generation cells are set to the third heat density q¹(i) estimated in the process of S207 (S208). The simulation executing unit 43 stores third temperature information indicating the temperature T¹(i) of each of the plurality of temperature cells calculated by executing the third simulation in the storage unit 11. The temperature of the first temperature cell is represented by T¹(1), the temperature of the second temperature cell is represented by T¹(2), and the temperature of the n-th temperature cell is represented by T¹(n).

Next, the temperature-distribution determining unit 46 determines whether the temperature difference between the temperature T¹(i) of each of the plurality of temperature cells corresponding to the third temperature information and the target temperature T_{target}(i) of the plurality of temperature cells is within a predetermined threshold temperature difference (S209). If the temperature-distribution determining unit 46 determines that the temperature difference between the temperature T¹(i) of each of the plurality of temperature cells corresponding to the third temperature information and the target temperature T_{target}(i) of the plurality of temperature cells is not within the predetermined threshold temperature difference (S209: NO), the process returns to S204.

When the process returns to S204, the heat-density setting unit 41 sets the heat densities of the plurality of heat generation cells to the second heat density q²_{search}(i) (=q¹(i)+Δq) obtained by adding the fixed value Δq to each of the third heat density q¹(i) estimated in the process of S207 (S204). Next, the simulation executing unit 43 executes the second simulation (S205), and the change-coefficient calculating unit 44 calculates a change coefficient a²(i) using Exp. (3) (S206). Next, the heat-density estimating unit 45 estimates a third heat density q¹(i) using Exp. (4) (S207), and the simulation executing unit 43 executes the third simulation (S208).

Until it is determined by the temperature-distribution determining unit 46 that the temperature difference is within the predetermined threshold temperature difference (S209: YES), the processes from S204 to S209 are repeated, with the second heat density set at qⁿ_{search}(i) (=qⁿ⁻¹(i)+Δq).

If the temperature-distribution determining unit 46 determines that the temperature difference is within the predetermined threshold temperature difference (S209: YES), the heat-density determining unit 47 determines the third heat density qⁿ(i) that is estimated last in the process of S207 as the heat density of the plurality of heat generation cells (S210).

Next, the temperature-distribution-information output unit 48 outputs the temperature Tⁿ(i) of each of the plurality of temperature cells corresponding to the third temperature information, which stored last in the storage unit 11 in the process of S208, as temperature distribution information on the temperature plane (S211). The heat-distribution-information output unit 49 outputs the heat density qⁿ(i) of each of the plurality of heat generation cells determined in the process of S210 as heat distribution information on the heat generation plane (S212).

S204 to S206 is a heat-density search routine for calculating a change coefficient indicating the change amount of the temperature with respect to the change amount of the heat density based on the execution result of the second simulation. S207 to S209 is a heat-distribution change routine for determining the heat density of each of the plurality of heat generation cells based on the change coefficient so that the temperature of each of the plurality of temperature cells reaches a desired target temperature.

Advantageous Effects of Heat Density Calculation Method According to Embodiment

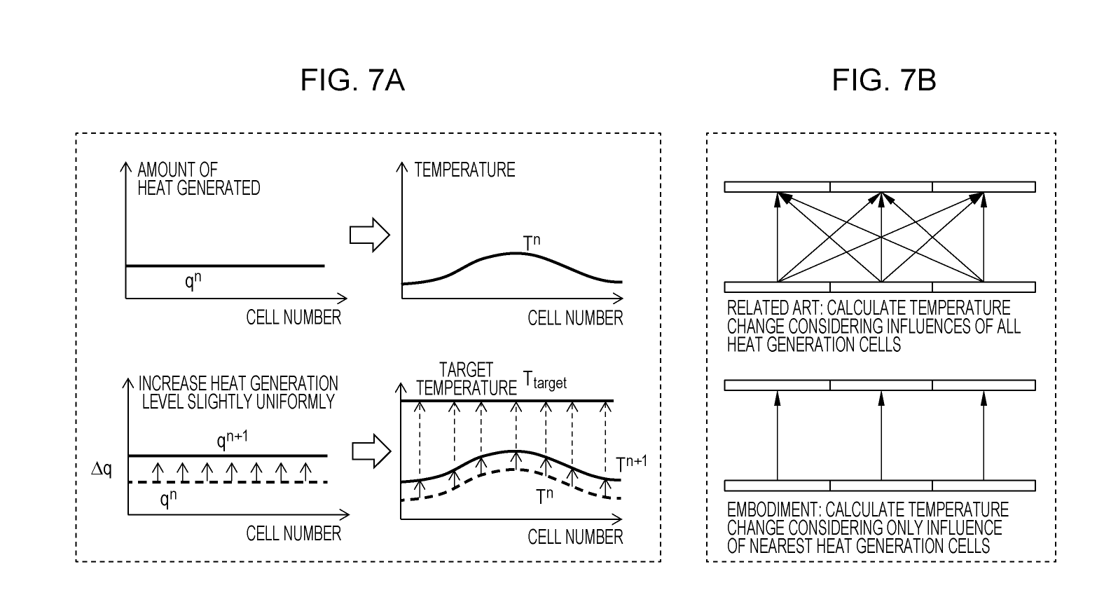

FIGS. 7A and 7B are diagrams illustrating the advantageous effects of the heat density calculation method according to the embodiment. FIG. 7A is a diagram illustrating the heat density calculation method according to the present embodiment. FIG. 7B is a diagram illustrating the difference between the heat density calculation method according to the embodiment and a heat density calculation method based on the thermogenic response matrix methodology.

In the heat density calculation method according to the present embodiment, the second simulation is executed, with the second heat densities of all of the plurality of heat generation cells set to qⁿ_{search}(i) (=qⁿ⁻¹(i)+Δq) using the first heat density q⁰(i) or the third heat density qⁿ(i). In the heat density calculation method according to the present embodiment, the change coefficient a²(i) is calculated based on the execution result of the second simulation, and the third heat density qⁿ(i) is estimated using the calculated change coefficient aⁿ(i). In the heat density calculation method according to the present embodiment, processing is repeated until the temperature difference between the temperature Tⁿ(i) of each temperature cell calculated by executing the third simulation in a state in which the heat density is set at the third heat density qⁿ(i) and the target temperature T_{target}(i) falls within a threshold temperature difference. In the heat density calculation method according to the present embodiment, the temperature Tⁿ(i) of each temperature cell is output as temperature distribution information, and the third heat density qⁿ(i) is output as heat distribution information when the temperature difference between the temperature Tⁿ(i) and the target temperature T_{target}(i) falls within the threshold temperature difference.

In the heat density calculation method according to the present embodiment, the heat density is calculated considering only the influence of a closest heat generation cell associated one-to-one and ignoring the influence of heat generation cells other than the heat generation cell associated one-to-one. In contrast, in the heat density calculation method based on the thermogenic response matrix methodology, the heat density is calculated considering the influence of all heat generation cells that divide the heat generation plane. The heat density calculation method according to the present embodiment reduces the number of simulations for calculating the change coefficient a²(i) as compared with the heat density calculation method based on the thermogenic response matrix methodology by ignoring the influence of the heat generation cells other than the heat generation cell associated one-to-one.

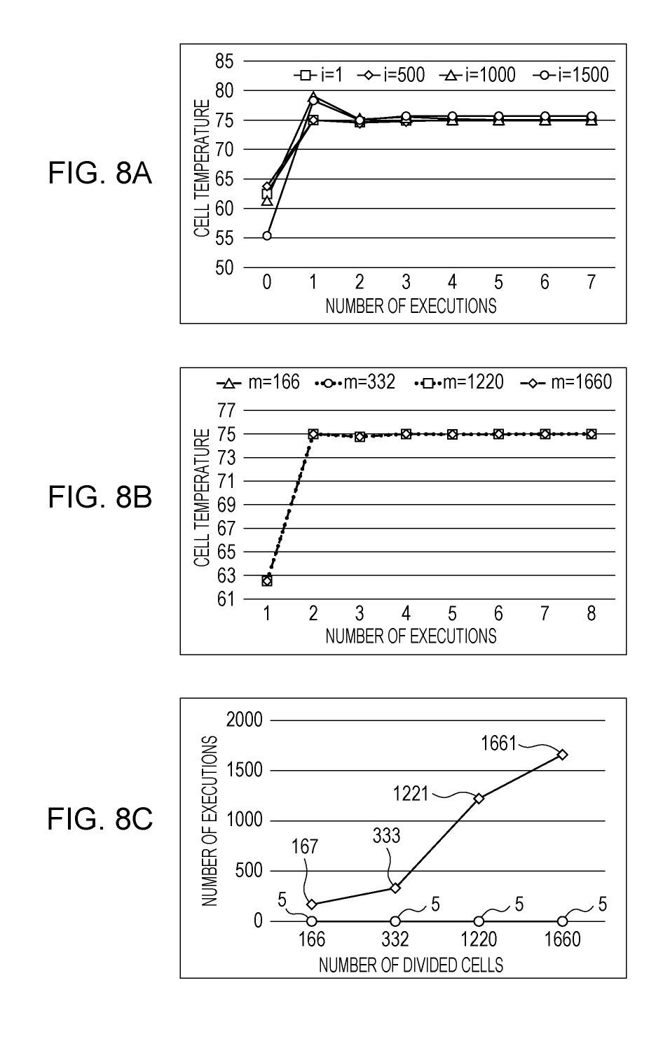

FIG. 8A is a graph illustrating an example of the calculation results of heat density by the heat density calculation method according to the present embodiment. FIG. 8B is a graph illustrating an example of the calculation results of heat density by the heat density calculation method according to the present embodiment when the number of heat generation cells is changed. FIG. 8C is a graph illustrating the comparison result of the number of executions of thermofluid analytical simulation by the heat density calculation method according to the present embodiment and the heat density calculation method based on the thermogenic response matrix methodology.

In the example illustrated in FIG. 8A, the heat generation cells and the temperature cells are respectively formed by dividing a circular heat generation plane and a circular temperature plane with the same area by concentric circles with different diameters, further dividing the concentric circles by a plurality of straight lines passing through the centers of the heat generation plane and the temperature plane into 1,660 sectors. The first heat generation cell and the first temperature cell are located at the centers of the heat generation plane and the temperature plane. The heat generation cells and the temperature cells are each assigned a cell number that increases in cell number with a decreasing distance to their outer peripheries. In FIG. 8A, the horizontal axis indicates the number of executions of simulation, and the vertical axis indicates the temperatures of the temperature cells, whose target temperature is 75° C. In FIG. 8A, the square mark represents the temperature of a temperature cell of cell number 1, the rhombic mark represents the temperature of a temperature cell of cell number 500, the triangle mark represents the temperature of a temperature cell of cell number 1000, and the circle mark represents the temperature of a temperature cell of cell number 1500.

The optimum solution of the temperatures of the first temperature cell located at the center of the temperature plane and the 1,500-th temperature cell located at the outer periphery of the temperature plane can be acquired by executing a total of five simulations of one time of first simulation, two times of second simulation, and two times of third simulation.

In the example illustrated in FIG. 8B, the heat generation plane and the temperature plane are respectively divided into 166, 332, 1,220, and 1,660 heat generation cells and temperature cells. In FIG. 8B, the horizontal axis indicates the number of executions of simulation, and the vertical axis indicates the temperatures of the temperature cells, whose target temperature is 75° C. In FIG. 8B, the square mark represents the temperature of a temperature cell of cell number 1 when the heat generation plane is divided into 166 heat generation cells, and the rhombic mark represents the temperature of a temperature cell of cell number 1 when the heat generation plane is divided into 332 heat generation cells. The triangle mark represents the temperature of a temperature cell of cell number 1 when the heat generation plane is divided into 1,220 heat generation cells, and the circle mark represents the temperature of a temperature cell of cell number 1 when the heat generation plane is divided into 1,660 heat generation cells.

In the case of the heat density calculation method according to the present embodiment, the number of executions of simulation for calculating a heat density at which the temperature of a temperature cell located at the center of the temperature plane reaches an optimum temperature does not change even if the number of cells divided is changed. Furthermore, with the heat density calculation method according to the present embodiment, the history of the temperature of the temperature cell located at the center of the temperature plane does not change even if the number of cells divided is changed.

In the example illustrated in FIG. 8C, the heat generation plane and the temperature plane are respectively divided into 166, 332, 1,220, and 1,660 heat generation cells and temperature cells. In FIG. 8C, the horizontal axis indicates the number of divided temperature cells, and the vertical axis indicates the number of executions of simulation. In FIG. 8C, the circular mark represents the number of executions of thermofluid analytical simulation in the heat density calculation method according to the present embodiment, and the rhombic mark represents the number of executions of thermofluid analytical simulation in the heat density calculation method based on the thermogenic response matrix methodology.

The number of executions of thermofluid analytical simulation in the heat density calculation method based on the thermogenic response matrix methodology increases in proportion to an increase in the number of divided temperature cells. The execution time of the thermofluid analytical simulation according to the heat density calculation method based on the thermogenic response matrix methodology is generally several hours. With the heat density calculation method based on the thermogenic response matrix methodology, if the number of divided temperature cells exceeds 1,000, and the execution time of the thermofluid analytical simulation exceeds 1,000, the heat density may not actually be calculated. In contrast, with the heat density calculation method according to the present embodiment, even if the number of divided temperature cells exceeds 1,000, the number of executions of the thermofluid analytical simulation does not increase from five, so that even if the number of divided temperature cells is increased, there is no risk of the heat density not being calculated.

Modification of Heat Density Calculation Method According to Embodiment

In the heat density calculation method described above, the heat generation plane and the temperature plane have a circular planar shape. Alternatively, in the heat density calculation method according to an embodiment, the heat generation plane and the temperature plane may have a rectangular or another shape, and may have an uneven portion, such as a screw hole.

In the heat density calculation method described above, the shape of the heat generation plane and the shape of the temperature plane are the same. Alternatively, in the heat density calculation method of according to an embodiment, the shape of the heat generation plane and the shape of the temperature plane may differ. In the heat density calculation method described above, the shape of the heat generation cells is the same as the shape of the temperature cells associated one-to-one therewith. Alternatively, in the heat density calculation method according to the embodiment, the shape of the heat generation cells may differ from the shape of the temperature cells associated one-to-one therewith.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a computer program for calculating heat density, the program causing a computer to perform a process comprising:
executing a first simulation of calculating a temperature of a temperature plane divided into a plurality of temperature cells associated one-to-one with a plurality of heat generation cells that divide a heat generation plane, with a heat density of each of the plurality of heat generation cells set at a first heat density, and storing first temperature information indicating the temperature of each of the plurality of temperature cells;
executing a second simulation of calculating a temperature of the temperature plane when the heat density of each of the plurality of heat generation cells is set to a second heat density obtained by adding a fixed value to each first heat density and storing second temperature information indicating the temperature of each of the plurality of temperature cells;
calculating a change coefficient indicating a change amount of the temperature with respect to a change amount of the heat density for each of the plurality of heat generation cells from a difference in the temperature of each of the plurality of temperature cells between the temperature corresponding to the first temperature information and the temperature corresponding to the second temperature information;
determining a heat density of each of the plurality of heat generation cells based on the change coefficients so that the temperature of each of the plurality of temperature cell reaches a desired target temperature; and
outputting the determined heat density of each of the plurality of heat generation cells.

2. The storage medium according to claim 1, wherein the process of determining the heat density of each of the plurality of heat generation cells comprises:
estimating a third heat density at which the temperature of a corresponding temperature cell matches the target temperature for each of the plurality of heat generation cells based on the change coefficient;
executing a third simulation of calculating the temperature of the temperature plane when the heat density of the plurality of heat generation cells is set to the third heat density and storing third temperature information indicating the temperature of each of the plurality of temperature cells;
determining whether a temperature difference between the temperature of each of the plurality of temperature cells corresponding to the third temperature information and the target temperature is within a predetermined threshold temperature difference; and
when it is determined that the temperature difference is within the threshold temperature difference, determining the estimated third heat density as the heat density of each of the plurality of heat generation cells.

3. The storage medium according to claim 2, further comprising:
when it is determined that the temperature difference is not within the threshold temperature difference, setting a heat density obtained by adding a fixed value to each third heat density as the second heat density,
wherein the computer program causes the computer to repeat a process of executing the second simulation using the second heat density set as a heat density obtained by adding a fixed value to each third heat density, a process of calculating the change coefficient from a difference in the temperature of each of the plurality of temperature cells between the temperature corresponding to the first temperature information and the temperature corresponding to the second temperature information, and the process of determining the heat density, until the temperature difference falls within the threshold temperature difference.

4. An information processing apparatus for calculating heat density, the apparatus comprising:
a memory, and
a processor coupled to the memory and configured to perform a process comprising:
executing a first simulation of calculating a temperature of a temperature plane divided into a plurality of temperature cells associated one-to-one with a plurality of heat generation cells that divide a heat generation plane, with a heat density of each of the plurality of heat generation cells set at a first heat density, and storing first temperature information indicating the temperature of each of the plurality of temperature cells;
executing a second simulation of calculating a temperature of the temperature plane when the heat density of each of the plurality of heat generation cells is set to a second heat density obtained by adding a fixed value to each first heat density and storing second temperature information indicating the temperature of each of the plurality of temperature cells;
calculating a change coefficient indicating a change amount of the temperature with respect to a change amount of the heat density for each of the plurality of heat generation cells from a difference in the temperature of each of the plurality of temperature cells between the temperature corresponding to the first temperature information and the temperature corresponding to the second temperature information;
determining a heat density of each of the plurality of heat generation cells based on the change coefficients so that the temperature of each of the plurality of temperature cell reaches a desired target temperature; and
outputting the determined heat density of each of the plurality of heat generation cells.

5. A method for calculating heat density performed by a causing a computer, the method comprising:
executing a first simulation of calculating a temperature of a temperature plane divided into a plurality of temperature cells associated one-to-one with a plurality of heat generation cells that divide a heat generation plane, with a heat density of each of the plurality of heat generation cells set at a first heat density, and storing first temperature information indicating the temperature of each of the plurality of temperature cells;
executing a second simulation of calculating a temperature of the temperature plane when the heat density of each of the plurality of heat generation cells is set to a second heat density obtained by adding a fixed value to each first heat density and storing second temperature information indicating the temperature of each of the plurality of temperature cells;
calculating a change coefficient indicating a change amount of the temperature with respect to a change amount of the heat density for each of the plurality of heat generation cells from a difference in the temperature of each of the plurality of temperature cells between the temperature corresponding to the first temperature information and the temperature corresponding to the second temperature information;
determining a heat density of each of the plurality of heat generation cells based on the change coefficients so that the temperature of each of the plurality of temperature cell reaches a desired target temperature; and
outputting the determined heat density of each of the plurality of heat generation cells.
